(19) United States
(12) Patent Application Publication
(10) Pub. No.: US 2017/0197533 A1
(43) Pub. Date: Jul. 13, 2017

(54) VEHICLE SEAT

(71) Applicant: Adient Luxembourg Holding S.à.r.l., Luxembourg (LU)

(72) Inventors: Markus SCHLITT, Overath (DE); Sebastian EVELS, Wuppertal (DE)

(21) Appl. No.: 15/402,638

(22) Filed: Jan. 10, 2017

(30) Foreign Application Priority Data
Jan. 11, 2016 (DE) 10 2016 200 193.0

(51) Int. Cl. B60N 2/68; B60N 2/20

(52) U.S. Cl. CPC B60N 2/682; B60N 2/20; B60N 2/686

(57) ABSTRACT

A vehicle seat (1), in particular a motor vehicle seat, has a seat part (4), a backrest (2) which has a backrest structure (20) as a supporting structure, and at least one fitting (6). The fitting (6) connects the backrest structure (20), at least indirectly, to the seat part (4) and is pivotble relative to the seat part (4). A backrest adapter (12) connects the backrest structure (20) to a fitting part of the at least one fitting (6); wherein the backrest structure (20) has a receiving space (22) in which the backrest adapter (12) is accommodated in a form-fitting manner at least in sections.

### REFERENCE TO RELATED APPLICATIONS

This application claims the benefit of priority under 35 U.S.C. §119 of German Application 10 2016 200 193.0 filed Jan. 11, 2016, the entire contents of which are incorporated herein by reference.

### FIELD OF THE INVENTION

The invention relates to a vehicle seat, in particular motor vehicle seat, with a seat part, a backrest which has a backrest structure as supporting structure, and at least one fitting by means of which the backrest structure is connected at least indirectly to the seat part and in particular is pivotable relative to the seat part, wherein a backrest adapter connects the backrest structure to a fitting part of the at least one fitting.

### BACKGROUND OF THE INVENTION

DE 103 27 639 A1 discloses a sports seat for a vehicle, with at least one rigid seat shell as structure for the seat part and with a separately formed, rigid backrest shell as structure for the backrest, which seat part and backrest are adjustable in inclination relative to each other, wherein the inclination adjustment takes place by means of two fittings which each have a fitting lower part which is fixedly connected to the seat shell and a fitting upper part which is connected to the backrest shell and is rotatable relative to the fitting lower part. The fitting upper parts are connected to the backrest shell by means of one backrest adapter each. For this purpose, the backrest shell has suitable fastening regions against which the backrest adapters lie flat and are screwed to the backrest shell. The fastening regions of the backrest shell are locally reinforced by inserts, in particular made of metal.

### SUMMARY OF THE INVENTION

The invention is based on the problem of improving a vehicle seat of the type mentioned at the beginning, in particular based on the problem of simplifying the mounting of the backrest structure on a fitting or on an adapter connected to a fitting. In particular, the mounting costs of the vehicle seat are intended to be reduced.

This problem is solved according to the invention by a vehicle seat, in particular motor vehicle seat, with a seat part, a backrest which has a backrest structure as supporting structure, and at least one fitting by means of which the backrest structure is connected at least indirectly to the seat part and in particular is pivotable relative to the seat part, wherein a backrest adapter connects the backrest structure to a fitting part of the at least one fitting, wherein the backrest structure has a receiving space in which the backrest adapter is form-fitting accommodated (accommodated in a form-fitting manner) at least in sections.

Owing to the fact that the backrest structure has a receiving space in which the backrest adapter is form-fitting accommodated (accommodated in a form-fitting manner) at least in sections, the backrest adapter does not have to be screwed or welded to the backrest structure. The receiving space can advantageously fix the backrest adapter in and counter to a longitudinal direction, in and counter to a transverse direction and also counter to a vertical direction. Fixing can take place by means of one or more walls which surround and form the receiving space.

The backrest adapter is preferably pushed into the receiving space and adhesively bonded therein. The backrest adapter can be adhesively bonded and/or clipped to backrest structure walls forming the receiving space. As a result, additional fastening components, such as, for example, screws, can be dispensed with. The omission of the screwing processes means that the costs for corresponding quality controls and tools are also omitted.

The receiving space is suitable for accommodating backrest adapters which are known per se. The receiving space can be adapted to the contours of the backrest adapters, or vice versa. By means of a construction kit with different backrest adapters, the backrest structure can be inserted into different vehicle seats without structural modifications. For example, a backrest structure can be connected unchanged to seat parts of different width by means of backrest adapters bent to differing degrees in the transverse direction.

The backrest structure preferably has two receiving spaces for receiving one backrest adapter each. The two receiving spaces can lie opposite each other, as viewed in the transverse direction. The two receiving spaces can be mirror-symmetrical with respect to each other. One of the two receiving spaces can each be arranged on one side of the seat in each case, as viewed in the transverse direction.

The backrest adapter is preferably connected to a fitting upper part of the at least one fitting. The fitting upper part can have a substantially circular shape. The fitting can have a fitting upper part and a fitting lower part which are rotatable relative to each other and are fixed in the axial direction with respect to each other by a clasp ring.

The receiving space can be a space which is at least partially closed in and counter to two directions in space. The receiving space can be a space which is completely bounded, in particular closed, in and counter to two directions in space. The receiving space can be closed in a third direction in space and open counter to the third direction in space. The receiving space is preferably a space which is closed on five sides with respect to a Cartesian system of coordinates. The receiving space can be pocket-shaped. The receiving space can be open on one side.

The form-fitting connection between the backrest adapter and the backrest structure in the receiving space can be in and counter to two directions in space. The form-fitting connection between the backrest adapter and the backrest structure can additionally be in a third direction in space and can be missing counter to the third direction in space. The form-fitting connection between the backrest adapter and the backrest structure preferably acts in five directions.

The receiving space is preferably open by means of an insertion opening for the backrest adapter. The backrest adapter can then be inserted into the receiving space of the backrest structure during the assembly of the vehicle seat. The receiving space preferably runs conically starting from the insertion opening, and therefore the backrest adapter is automatically centered when inserted into the receiving space.

The backrest structure can be formed from profiles and/or semi-finished products. The backrest structure can be formed from deformed metal sheets. The backrest structure is preferably a backrest shell. The backrest structure can be substantially constructed from a composite material, in particular a fiber composite material. The backrest structure can be a carbon shell.

Owing to the fact that the backrest structure has a receiving space into which the backrest adapter can be pushed and can be form-fitting fixed (fixed in a form-fitting manner), screw-on points, such as, for example, weld nuts or collar formations with threads, do not have to be provided on the backrest structure. This reduces costs, weight and manufacturing times.

In the case of a backrest shell configured according to the invention, additional inserts, in particular metal inserts, for connecting the backrest adapters to the backrest shell can be dispensed with because forces can be introduced uniformly and extensively into the backrest shell by a backrest adapter. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic side view of a vehicle seat according to the invention;

FIG. 2 is a seat structure of the vehicle seat from FIG. 1 in a mounted state;

FIG. 3 is the seat structure from FIG. 2 in an exploded illustration; and

FIG. 4 is a detailed view of a lower region of a backrest structure of the vehicle seat according to the invention.

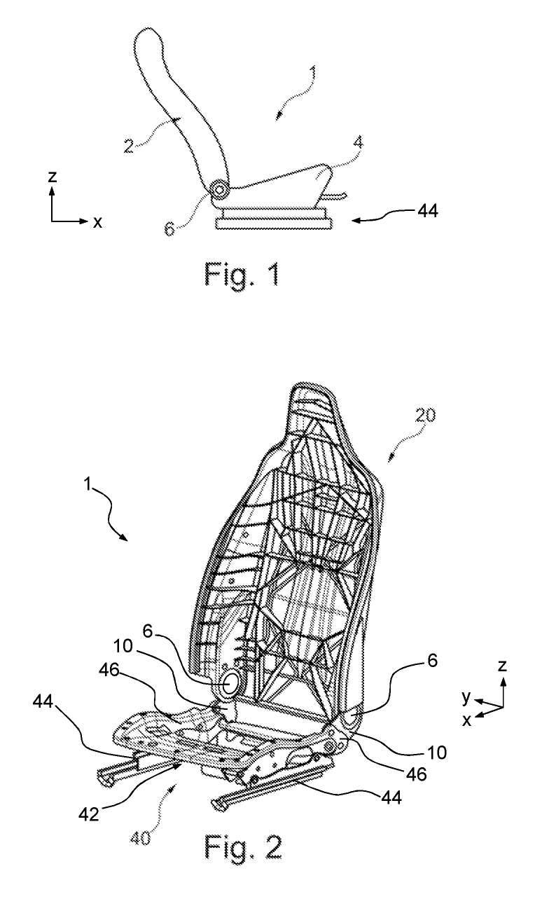

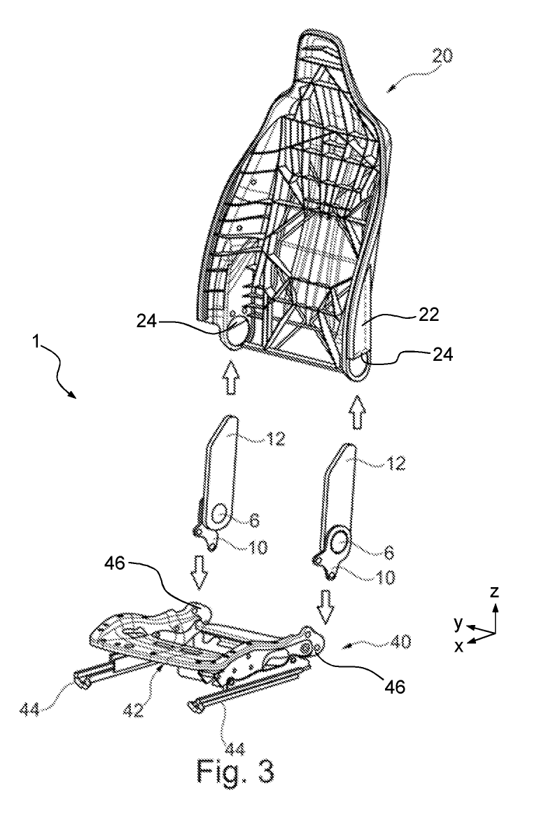

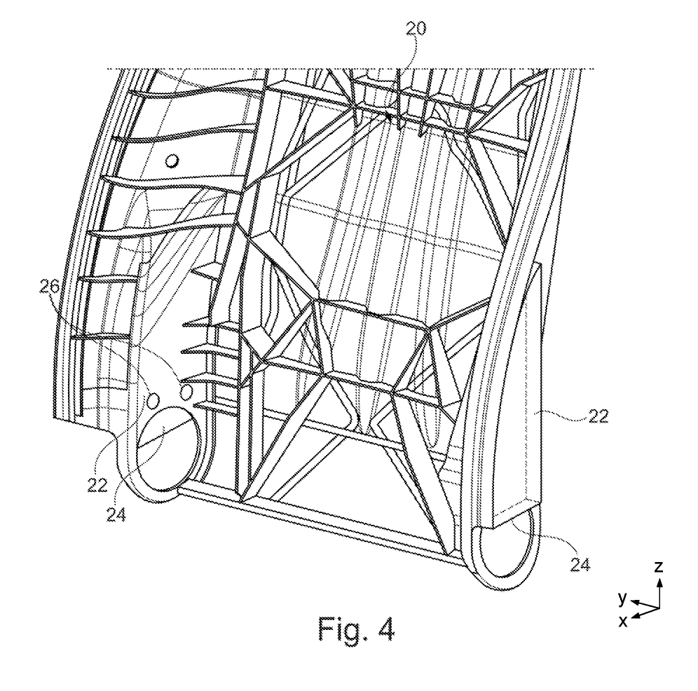

### DESCRIPTION OF THE PREFERRED EMBODIMENTS

Referring to the drawings, a vehicle seat 1, which is illustrated in the figures, for a motor vehicle is described below using three directions in space running perpendicularly to one another. In the case of a vehicle seat 1 installed in the vehicle, a longitudinal direction x runs substantially horizontally and preferably parallel to a vehicle longitudinal direction which corresponds to the customary direction of travel of the vehicle. A transverse direction y running perpendicularly to the longitudinal direction x is likewise oriented horizontally in the vehicle and runs parallel to a vehicle transverse direction. A vertical direction z runs perpendicularly to the longitudinal direction x and perpendicularly to the transverse direction y. In the case of a vehicle seat 1 installed in the vehicle, the vertical direction z runs parallel to the vehicle vertical axis.

The position and direction details used, such as, for example, front, rear, top and bottom refer to a viewing direction of an occupant sitting in the vehicle seat 1 in a normal sitting position, wherein the vehicle seat 1 is installed in the vehicle and is in a use position suitable for conveying an individual. The vehicle seat 1 is oriented here in the direction of travel as customary, but may also be installed in a differing orientation, for example transversely with respect to the direction of travel.

The vehicle seat 1 has a backrest 2 and a seat part 4. The backrest 2 is connected to the seat part 4 by means of one fitting 6 on each of the two outer sides of the seat and is adjustable in inclination relative to the seat part 4.

The invention is not restricted to a certain embodiment of the fitting 6. The two fittings 6 may each be designed as a latching fitting, as is known, for example, from DE 10 2009 041 492 A1 (corresponding to US 2012/0169105 A1). Alternatively, the fittings 6 can each be designed as a geared fitting, as is known, for example, from DE 10 2010 012 980 A1 (corresponding to US 2012/0277050 A1). The two fittings 6 are operatively connected to each other preferably via a transmission rod which is not illustrated in the figures and is arranged horizontally in the transition region between seat part 4 and backrest 2. On both sides of the vehicle seat 1, the transmission rod engages in each case one of the two fittings 6. A rotation of the transmission rod brings about an unlocking and locking (latching fitting) or an adjustment (geared fitting) of the two fittings 6.

The backrest 2 has, as supporting structure, a backrest structure 20 which is designed here as a backrest shell and is upholstered in a manner known per se with at least one foam part and a cover.

The seat part 4 has, as supporting structure, a seat part structure 40 which is upholstered in a manner known per se with at least one foam part and a cover. The seat part structure 40 comprises a seat frame 42 which is connectable to a vehicle floor by means of two seat rail pairs 44 which are known per se. The vehicle seat 1 is longitudinally adjustable in the longitudinal direction x relative to the vehicle floor by means of the two seat rail pairs 44.

Each of the two fittings 6 has in each case a fitting lower part and a fitting upper part which are rotatable relative to each other about a backrest pivot axis arranged parallel to the transverse direction y. In order to connect the fittings 6 to the seat part 4, a seat part adapter 10 is in each case fastened, preferably welded, to each fitting lower part. The seat part adapters 10 are in each case connected, preferably screwed, to an associated seat frame side part 46 of the seat frame 42. For the fastening of the fittings 6 to the backrest 2, a backrest adapter 12 is in each case fastened, preferably welded, to each fitting upper part. The backrest adapters 12 are fixedly connected to the backrest structure 20 in a manner described in more detail below.

In the present case, the backrest structure 20 is a carbon shell, with carbon nonwoven fabric and/or carbon endless fibers. Alternatively, the backrest structure 20 can be formed from another suitable fiber composite material, such as, for example, glass fiber reinforced plastic, or an injection moulding material, such as plastic, aluminum or magnesium.

As viewed in the transverse direction y, the backrest structure 20 has in each case on both sides a receiving space 22 for receiving the respectively correspondingly arranged backrest adapter 12. The receiving space 22 is formed in the shape of a pocket in the backrest structure 20. The receiving space 22 is configured in the manner of a downwardly open slip case. In the present case, the receiving space 22 is a space, which is closed on five sides, in the backrest structure 20. An insertion opening 24 opens the receiving space 22 downwards, and therefore, during assembly of the vehicle seat 1, the corresponding backrest adapter 12 can be inserted from below into the backrest shell 20.

The two backrest adapters 12 each have an elongate configuration. In the present case, the two backrest adapters 12 are in each case sword-shaped. The two backrest adapters 12 are formed flat and are substantially parallel to a plane defined by the longitudinal direction x and the vertical direction z. Each of the two receiving spaces 22 is enclosed at least in sections by means of inner walls which substantially correspond to the contour of the backrest adapter 12. In the assembled state of the vehicle seat 1, the backrest adapters 12 are inserted into the associated receiving spaces 22 and adhesively bonded to the backrest structure 20, in particular to the inner walls. In modifications of the exemplary embodiment, the backrest adapters 12 can be screwed to the backrest structure 20 alternatively or additionally to the adhesive bonding. For this purpose, a wall of the backrest structure 20 that is oriented towards the center of the seat in each case has two screw through holes 26. The backrest adapters 12 then have, for example, corresponding threads.

A method for producing the backrest structure 20, which is designed in the present case as a backrest shell, can make provision for the required contours of the preferably two receiving spaces 22 to be formed in one or more method steps in a mould for producing the backrest structure 20, for example an injection mould, by means of inserts and/or mould slides. After the receiving spaces 22 are shaped, the inserts and/or mould slides are removed from the receiving spaces 22.

A method for assembling the vehicle seat 1 can make provision for the seat part adapters 10 to be fastened in one method step to the seat part structure 40, in particular for the seat part adapters 10 to be screwed to the seat frame side parts 46 before the backrest structure 20 is plugged onto the backrest adapter 12 in a further method step.

An alternative method for assembling the vehicle seat 1 makes provision for the backrest structure 20 to be plugged in one method step onto the backrest adapter 12 before the seat part adapters 10 are fastened in a further method step to the seat part structure 40, in particular before the seat part adapters 10 are screwed to the seat frame side parts 46.

The features disclosed in the above description, the claims and the drawings may be of importance both individually and in combination for realizing the invention in its various refinements.

Although the invention has been described in detail in the drawings and in the preceding illustration, the illustrations should be understood as illustrative and by way of example and non-limiting. In particular, the choice of the graphically illustrated proportions of the individual elements should not be interpreted as required or restrictive. Furthermore, the invention is in particular not restricted to the exemplary embodiments explained. Further variants of the invention and the realization thereof emerge to a person skilled in the art from the preceding disclosure, the figures and the claims. While specific embodiments of the invention have been shown and described in detail to illustrate the application of the principles of the invention, it will be understood that the invention may be embodied otherwise without departing from such principles.

What is claimed is:

1. A vehicle seat comprising:
a seat part;
a backrest having a backrest structure as a supporting structure;
at least one fitting pivotally connecting the backrest structure, at least indirectly, to the seat part; and
a backrest adapter connecting the backrest structure to a fitting part of the at least one fitting, wherein the backrest structure has a receiving space in which the backrest adapter is form-fitting accommodated in at least in sections.

2. A vehicle seat according to claim 1, wherein the backrest adapter is pushed into the receiving space and adhesively bonded therein.

3. A vehicle seat according to claim 1, wherein the backrest adapter is form-fitting fixed in at least two directions in space by means of walls of the receiving space.

4. A vehicle seat according to claim 1, wherein the backrest structure has two receiving spaces, each of the receiving spaces being for receiving one backrest adapter.

5. A vehicle seat according to claim 1, wherein the receiving space is a partially enclosed space.

6. A vehicle seat according to claim 1, wherein the receiving space is open on one side, and is a space which is closed on five sides.

7. A vehicle seat according to claim 1, wherein the receiving space has an insertion opening, whereby the receiving space is open in a direction of the fitting.

8. A vehicle seat according to claim 7, wherein the receiving space is formed conically starting from the insertion opening.

9. A vehicle seat according to claim 1, wherein the backrest structure is a backrest shell.

10. A vehicle seat according to claim 1, wherein the backrest structure is substantially formed from a composite material comprising a fiber composite material.

11. A motor vehicle seat comprising:
a seat part;
a backrest having a backrest supporting structure defining a first side open case with a first side case interior receiving space with a first side case receiving space form and defining a second side open case with an second side case interior receiving space with a second side case receiving space form;
a first side backrest adapter with an elongate portion with a shape conformed to the first side case receiving space form, the elongate portion of the first side backrest adapter being positioned in the first side case receiving space;
a second side backrest adapter with an elongate portion with a shape conformed to the second side case receiving space form, the elongate portion of the second side backrest adapter being positioned in the second side case receiving space;
a first side fitting pivotally connecting the seat part to the first side backrest adapter; and
a second side fitting pivotally connecting the seat part to the second side backrest adapter.

12. A motor vehicle seat according to claim 11, wherein the first side backrest adapter is fixed in the first side case interior receiving space by an adhesive and the second side backrest adapter is fixed in the second side case interior receiving space by an adhesive.

13. A motor vehicle seat according to claim 11, wherein:
the elongate portion of the first side backrest adapter has sides form-fitted with corresponding walls of the first side case interior receiving space, whereby the elongate portion of the first side backrest adapter is restrained in at least two directions by the walls of the first side case interior receiving space;
the elongate portion of the second side backrest adapter has sides form-fitted with corresponding walls of the second side case interior receiving space, whereby the elongate portion of the second side backrest adapter is restrained in at least two directions by the walls of the second side case interior receiving space.

14. A motor vehicle seat according to claim 11, wherein each receiving space has a shape of a pocket

15. A motor vehicle seat according to claim 11, wherein each receiving space is a partially enclosed space.

16. A motor vehicle seat according to claim 11, wherein each receiving space is open on one side, and is closed on five sides.

17. A motor vehicle seat according to claim 11, wherein each receiving space has an insertion opening, whereby the receiving space is open in a direction of the fitting.

18. A motor vehicle seat according to claim 17, wherein each receiving space is formed conically starting from the insertion opening.

19. A motor vehicle seat according to claim 11, wherein the backrest structure is a backrest shell.

20. A motor vehicle seat according to claim 11, wherein the backrest structure comprises a fiber composite material.
